(19) United States
(12) Patent Application Publication
(10) Pub. No.: US 2006/0056422 A1
(43) Pub. Date: Mar. 16, 2006

(54) Communication system having decentralized gateway selection

(75) Inventor: Winfried Antonius Henricus Berkvens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/537,595

(22) PCT Filed: Nov. 17, 2003
(86) PCT No.: PCT/IB03/05202

§ 371 Date: Jun. 6, 2005

(30) Foreign Application Priority Data
Dec. 9, 2002 (EP) 02080160.1

(51) Int. Cl. H04L 12/56

(52) U.S. Cl. 370/401

(57) ABSTRACT

A communication system comprises networks and gateway means (interconnecting the networks. One of the networks comprises a communication device having means for sending a communication request to at least one is of the gateway means, and the gateway means have means for sending an answer back to the communication device. The communication device further has means for selecting gateway means, based on the answer received from the at least one gateway means. Now the communication device is provided with local intelligence, so that the communication device itself can deal locally with the proper selection of the gateway means. Based on the responses from the responding gateways a customised choice can be made with respect to the particular gateway that will be involved in the making of the actual connection between the communication device and the network concerned.

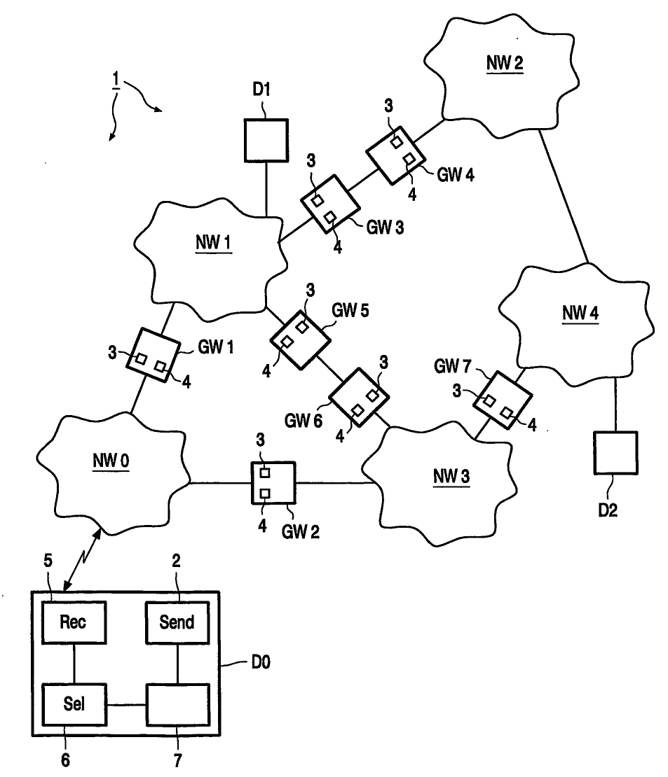

The present invention relates to a communication system comprising networks and gateway means interconnecting the networks, one of the networks comprises a communication device having means for sending a communication to at least one of the gateway means, and the gateway means having means for sending a message to the communication device.

The present invention also relates to a method effecting communication through at least one gateway.

From EP-A-1122915 such a communication system and method are known. The communication system comprises networks interconnected by gateway means. One of the networks comprises a server communication device, which in one embodiment has means for sending announcement communications to at least one of the gateway means. The gateway means has means for sending a request message to the server device to which the server may respond. In another embodiment a central call manger in response to requesting by a user selects a transmission path for a virtual leased IP line, which path provides at least a guaranteed minimum bandwidth sufficient to accommodate the predetermined IP traffic usage. The same call manager deals with reserving the bandwidth for the transmission path.

It is a disadvantage of the communication system according to the invention that a central call manager has to deal with selection and reservation of a required transmission path.

Therefore it is an object of the present invention to provide a communication system and method providing more flexibility and focus on the customising of the making a choice respecting the transmission path.

Thereto the communication system according to the invention is characterised in that the communication contains a communication request, that the message contains an answer in response to the communication request, and that the communication device further has means for selecting gateway means, based on the answer received from the at least one gateway means.

Similarly the method according to the invention is characterised in that a communication request is sent to one or more gateways, which send an answer back in response to the communication request, where after based on the received answer(s) the at least one gateway is selected.

It is an advantage of the communication system according to the invention that the communication device is provided with local intelligence, so that the communication device itself can deal locally with the proper selection of the gateway means. Now based on the communication request from the communication device and the responses from the responding gateways a customised choice can be made with respect to the particular gateway that will be involved in the making of the actual connection between the communication device and the gateway concerned. The communication system according to the invention enables communication devices, such as for example end-devices, in particular Internet Protocol (IP) end devices to select the gateway means, such as a residential gateway or router that suits a requested connection best, without the need of an end-user or consumer to be involved in this selection process. Furthermore the communication device according to the invention enables communication devices to select and use different gateways means for several connections originated or destined to a same communication device. It may for example be used to provide a more intelligent way of selecting routers on a network, such as the Internet. In addition the selection process adjusts well and in a cost effective way to the common “plug and play” principle used when communication devices are simply added to the system or network, which is also but not exclusively beneficial to home based networks sometimes having multiple residential gateways.

An embodiment of the communication device according to the invention is characterised in that the means for sending are arranged for broadcasting the communication request to each of the gateway means.

Advantageously it is ensured that all gateways which can possibly be selected by the communication device are provided with the communication request.

Another embodiment of the communication device according to the invention is characterised in that the communication device has means for sending a communication acknowledge message to the selected gateway means, and possibly to non selected gateway means.

After performing a comparison between the answers from the gateways the selected gateway is sent the communication acknowledge message, where after the connection set-up can start.

Another further advantageous embodiment of the communication device according to the invention is characterised in that the communication device has means for receiving an answer to the communication request from the gateway means.

Still another embodiment of the communication device according to the invention is characterised in that the gateway means have means for sending on the communication request to one or more other gateway means.

Generally the communication request will pass more than one gateway to end up in the network where the communication device would like to communicate with some other device. For such cases the selection of chains of gateways can be made accordingly.

A further embodiment of the communication device according to the invention is characterised in that the gateway means have means for receiving an answer to the communication request from the other gateways.

In the chain of gateways each gateway will be able to receive answers from the other gateways in order to send a final answer back to the communication device.

A still further embodiment of the communication system according to the invention is characterised in that the communication request comprises data which is relevant to minimum required communication features.

Generally only if the requirements with regard to the minimum communication features are fulfilled can a gateway be selected. Examples of such communication features are items like: available bandwidth, maximum transmission rate, required bit error rate, non-blocking rate, experienced jitter or delay over the selected gateway(s), costs involved in the communication, available service and support for the service, available processing power or storage capacity, opening/closing time of the selected gateway(s).

At present the communication device and method according to the invention will be elucidated further together with their additional advantages, while reference is being made to the appended drawing, showing a general outline of the communication system according to the invention.

The sole drawing shows a communication system 1. The communication system 1 comprises generally a plurality of networks NW0 . . . NW4 and associated gateway means GW1 . . . GW7 interconnecting the networks NW0 . . . NW4. One of the networks say NW0 comprises a communication device here D0 wanting to communicate with some other device, for example D1 or D2. The communication device D0 is provided with means 2 for sending a communication to at least one of the gateway means here by way of example GW1, but possibly such a communication may be broadcast to all gateway means, here GW1 and GW2. In an Internet network environment the sending of a communication by the gateway means 2 usually has the form of a so called multi-cast or uni-cast. The communication sent comprises a communication request for these gateway means. By means of the communication request the device D0 wants to find out whether there is a possibility to built a wanted connection through one of the gateway means GW1 . . . GW7 to the device D1. This request may as mentioned have any format or form, such as for example broadcast, multi-cast or ini-cast. Of course the protocol used in the system 1 is such that it is capable of embedding the communication request as well as the answers thereto. Apart from means 3 for receiving the communication request the gateway means concerned comprise means 4 for sending a message, in the form of an answer to the request. Any other available path not necessarily through the network NW0 itself may be used to communicate request and answer between the device D0 and the gateway means GW1 . . . GW7. Examples of other possible paths are: a telephone line or network, a cable network, a wireless network, an infrared network and the like. The communication device 1 as shown in the figure comprises means 5 for receiving the one or more answers from the gateway means GW1 and GW2. The communication device D0 further has means 6 for selecting gateway means, based on the answer(s) received from the at least one gateway means GW1 . . . GW7. The selection means 6 are coupled to means 7 for building up a connection and sending a communication acknowledge message to the selected gateway means. In this example it may be that gateway GW1 already knows that D1 is coupled to its associated network NW1 and that D1 is available for communication. If this is not the case then gateway GW1 will send appropriate requests to find device D1 in network NW1 and to acquire information about its availability. If a communication request is received by the receiving means 3 in gateway GW2 then GW2 will send on a communication request to neighbouring gateways, which in turn may send further communication requests et cetera. In this example a second gateway path may run through GW2, GW6, GW5 to D1, whereas a third gateway path may run through networks NW3, NW4, NW2 to D1 in network NW1. Finally al practical possibilities for a communication to D1 are gathered by D0, where a selection is made as to the preferred gateways by the selection means 6.

In general the communication request sent by the communication device D0 will comprise data which is relevant to minimum required communication features. Non limiting examples of these communication features are: available bandwidth, maximum transmission rate, required bit error rate, non-blocking rate, experienced jitter or delay over the selected gateway(s), costs involved in the communication, available service and support for the service, available processing power or storage capacity, opening/closing time of the selected gateway(s). In their answers the gateways will inform the communication device D0 about their possibility to coop with the requirements, in order to allow the selection means 6 to make a proper selection. All gateway means which are able to support the requested minimum required communication features will upon receipt of a communication request reserve these features until a gateway means is informed about its non selection for the actual connection, of is for example timed out by its internal timer, due to the laps of a predetermined amount of time.

A computer program, which is suited for implementing the method, wherein communication is effected through at least one gateway GW1 . . . GW7, wherein a communication request is sent to one or more gateways which send an answer back in response to the communication request, and wherein based on the received answer the at least one gateway GW1 . . . GW7 is selected, can be programmed easily, based on the above description.

1. A communication system comprising networks and gateway means interconnecting the networks, one of the networks comprises a communication device having means for sending a communication to at least one of the gateway means, and the gateway means having means for sending a message to the communication device, characterised in that the communication contains a communication request, that the message contains an answer in response to the communication request, and that the communication device further has means for selecting gateway means, based on the answer received from the at least one gateway means.

2. The communication system according to claim 1, characterised in that the means for sending are arranged for broadcasting the communication request to each of the gateway means.

3. The communication system according to claim 1, characterised in that the communication device has means for sending a communication acknowledge message to the selected gateway means, and possibly to non selected gateway means.

4. The communication device according to claim 1, characterised in that the communication device has means for receiving an answer to the communication request from the gateway means.

5. The communication system according to claim 1, characterised in that the gateway means have means for sending on the communication request to one or more other gateway means.

6. The communication system according to claim 5, characterised in that the gateway means have means for receiving an answer to the communication request from the other gateways.

7. The communication system according to claim 1, characterised in that the communication request comprises data which is relevant to minimum required communication features.

8. The communication system according to claim 7, characterised in that the communication features at least comprise one of the following items: available bandwidth, maximum transmission rate, required bit error rate, non-blocking rate, experienced jitter or delay over the selected gateway(s), costs involved in the communication, available service and support for the service, available processing power or storage capacity, opening/closing time of the selected gateway(s).

9. Gateway means for application in the communication system according to claim 1, the communication system comprising networks and gateway means interconnecting the networks, one of the networks comprises a communication device having means for sending a communication to at least one of the gateway means, and the gateway means having means for sending a message to the communication device, characterised in that the communication contains a communication request, that the message contains an answer to the communication request, and that the communication device further has means for selecting gateway means, based on the answer received from the at least one gateway means.

10. A method effecting communication through at least one gateway, characterised in that a communication request is sent to one or more gateways, which send an answer back in response to the communication request, where after based on the received answer(s) the at least one gateway is selected.

11. A computer program suited for implementing the method according to claim 10, wherein communication is effected through at least one gateway, wherein a communication request is sent to one or more gateways which send an answer back in response to the communication request, and based on the received answer the at least one gateway is selected.

12. A protocol suited for applying the method according to claim 10, wherein communication is effected through at least one gateway, wherein a communication request is sent to one or more gateways which send an answer back in response to the communication request, and based on the received answer the at least one gateway is selected.
